(19) United States
(12) Patent Application Publication
(10) Pub. No.: US 2016/0281949 A1
(43) Pub. Date: Sep. 29, 2016

(54) VEHICLE LIGHTING FIXTURE

(71) Applicant: Stanley Electric Co., Ltd., Tokyo (JP)

(72) Inventor: Keisuke Igarashi, Tokyo (JP)

(21) Appl. No.: 15/078,137

(22) Filed: Mar. 23, 2016

(30) Foreign Application Priority Data
Mar. 24, 2015 (JP) 2015-060860

(51) Int. Cl. F21S 8/10

(52) U.S. Cl. CPC F21S 48/137; F21S 48/1159; F21Y 2101/02

(57) ABSTRACT

A vehicle lighting fixture is capable of forming a light distribution pattern with higher light intensity while suppressing generation of glare light. A vehicle lighting fixture can include two light sources; a center reflecting surface having a focal line passing through centers of emission faces of the two light sources; lateral reflecting surfaces extending from respective lateral edges of the center reflecting surface and each obtained by moving a parabola obliquely sideward, with the parabola having a focal point located at a farthest front corner of the emission face of the closer point light source; and plate reflecting surfaces forming a substantially L-letter shape with a bent point interposed therebetween and each formed from a paraboloidal columnar surface obtained by moving a parabola obliquely forward and downward, with the parabola having a focal point located at a farthest front corner of the emission face of the closer point light source.

This application claims the priority benefit under 35 U.S.C. §119 of Japanese Patent Application No. 2015-060860 filed on Mar. 24, 2015, which is hereby incorporated in its entirety by reference.

### TECHNICAL FIELD

The presently disclosed subject matter relates to vehicle lighting fixtures, and in particular, to a vehicle lighting fixture capable of forming desired light distribution characteristics by light rays that are emitted from a plurality of light sources and reflected by a plurality of reflecting surfaces.

### BACKGROUND ART

Conventional vehicle lighting fixtures of this type include those disclosed in Japanese Patent Application Laid-Open No. 2013-191325 as a “vehicle headlight,” which corresponds to US2013/0235601A1.

FIGS. 1A to 1C are a schematic configuration diagram of a vehicle headlight 80 disclosed in the publication, a diagram illustrating how a light source 81 emits light rays, and a diagram illustrating how a light source 83 emits light rays, respectively. As illustrated in these drawings, the vehicle headlight 80 includes three light sources 81, 82, and 83. The light source 81 can be disposed at a focal point of a paraboloidal mirror 85, and the other two light sources 82 and 83 can be disposed at respective positions different from the focal point of the paraboloidal mirror 85. Light rays emitted from the respective light sources 81, 82, and 83 can be reflected by the paraboloidal mirror 85 to be projected at respective different ranges, thereby forming a desired light distribution pattern.

In the vehicle headlight 80 with the above-mentioned configuration, the light rays emitted by the plurality of light sources 81, 82, and 83 and reflected by the paraboloidal mirror 85 can be projected to respective different target positions to enlarge the formation region of the light distribution pattern. Thus, there is no challenge to improve the light distribution pattern with higher light intensity.

### SUMMARY

The presently disclosed subject matter was devised in view of these and other problems and features in association with the conventional art. According to an aspect of the presently disclosed subject matter, a vehicle lighting fixture can be configured to be capable of forming a desired light distribution pattern with higher light intensity by light rays that are emitted from a plurality of light sources and reflected by a plurality of reflecting surfaces while suppressing generation of glare light.

According to another aspect of the presently disclosed subject matter, a vehicle lighting fixture can include two point light sources; a reflector having reflecting surfaces configured to reflect light rays emitted from the two light sources; and a light shielding member configured to shield part of the light rays emitted from the two light sources. In the vehicle lighting fixture, the two point light sources can each have an emission face, and be disposed on a same plane so that the emission faces face in a same direction. The reflecting surfaces of the reflector can include a center reflecting surface disposed below the two point light sources and lateral reflecting surfaces on both sides of the center reflecting surface, the lateral reflecting surfaces each including a center part. The light shielding member can be disposed on straight lines each connecting any one of the two point light sources and the center part of any farther one of the lateral reflecting surfaces with respect to the one point light source. The lateral reflecting surfaces can each be formed from a curved columnar surface obtained by moving a parabola obliquely sideward, with the parabola having a focal point located at a farthest front corner of the emission face of the point light source on a side closer to the lateral reflecting surface of interest.

According to still another aspect of the presently disclosed subject matter, the vehicle lighting fixture according to the previous aspect can be configured such that the light shielding member can include a reflecting surface in substantially an L-letter shape, and parts of the reflecting surface on both extension sides of the L-letter shape can be formed from a paraboloidal columnar surface obtained by moving a parabola obliquely forward and downward, with the parabola having a focal point located at a farthest front corner of the emission face of the point light source on a side closer to the part of the L-letter shaped reflecting surface of interest.

In the vehicle lighting fixture with the above-mentioned configuration, the point light source can be a light emitting diode (LED).

According to the presently disclosed subject matter, the center reflecting surface disposed below the two point light sources can be formed from a paraboloidal columnar surface obtained by laterally moving a parabola having an axis inclined forward and downward, with the parabola having a focal line passing through centers of the emission faces of the two point light sources so as to reflect the light rays emitted from the two point light sources to a forward and downward position in front of the vehicle lighting fixture. Furthermore, the lateral reflecting surfaces disposed on both the sides of the center reflecting surface can be configured to reflect the light rays emitted from the two point light sources to a forward, inward and downward position in front of the vehicle lighting fixture. Further, the light shielding portion can be configured to shield the light rays emitted from the two point light sources and directed to any farther one of the lateral reflecting surfaces.

The vehicle lighting fixture with this configuration can prevent the generation of glare light thereby ensuring front visibility of a driver of an oncoming vehicle.

Furthermore, the light shielding member can include the reflecting surface configured to reflect the light rays emitted from the point light sources to forward, downward and outward positions. As a result, the vehicle lighting fixture can suppress the generation of glare light while providing the desired light distribution pattern with higher light intensity.

### BRIEF DESCRIPTION OF DRAWINGS

These and other characteristics, features, and advantages of the presently disclosed subject matter will become clear from the following description with reference to the accompanying drawings, wherein:

FIGS. 1A to 1C are a schematic configuration diagram of a vehicle headlight 80 disclosed in the publication, a cross-sectional view illustrating how a light source 81 emits light rays, and a cross-sectional view illustrating how a light source 83 emits light rays, respectively;

FIG. 2 is a perspective view of a vehicle lighting fixture made in accordance with principles of the presently disclosed subject matter when observed from an obliquely upper position;

FIG. 3 is a front view illustrating the vehicle lighting fixture;

FIG. 4 is a top view illustrating the vehicle lighting fixture;

FIG. 5 is a diagram illustrating emission light rays from the light sources; and

FIG. 6A to 6D are diagrams each illustrating a light distribution pattern formed on a virtual vertical screen.

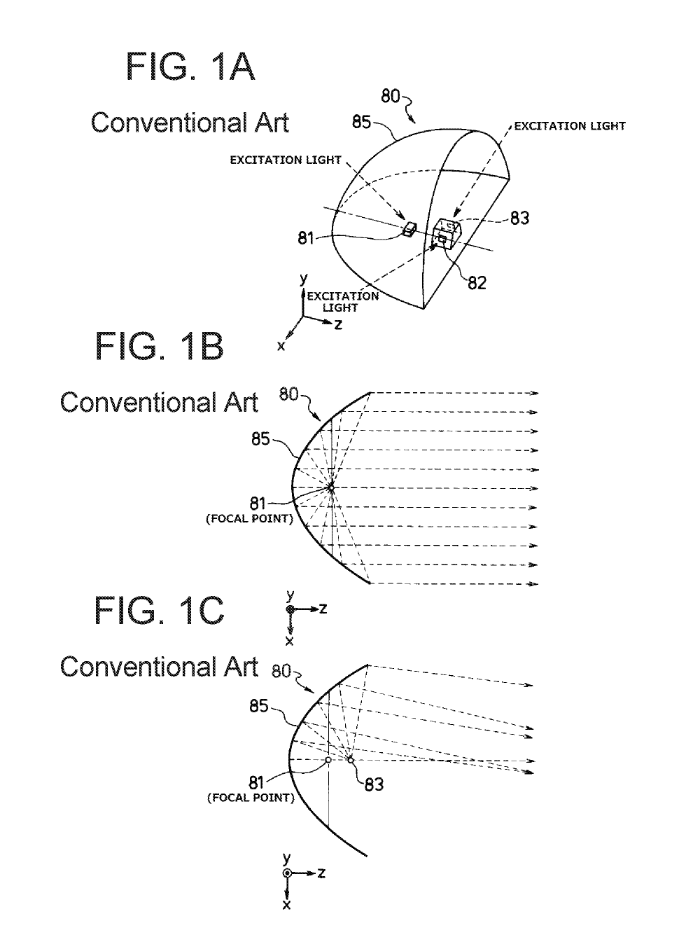

### DESCRIPTION OF EXEMPLARY EMBODIMENTS

A description will now be made below to a vehicle lighting fixture of the presently disclosed subject matter with reference to the accompanying drawings in accordance with exemplary embodiments.

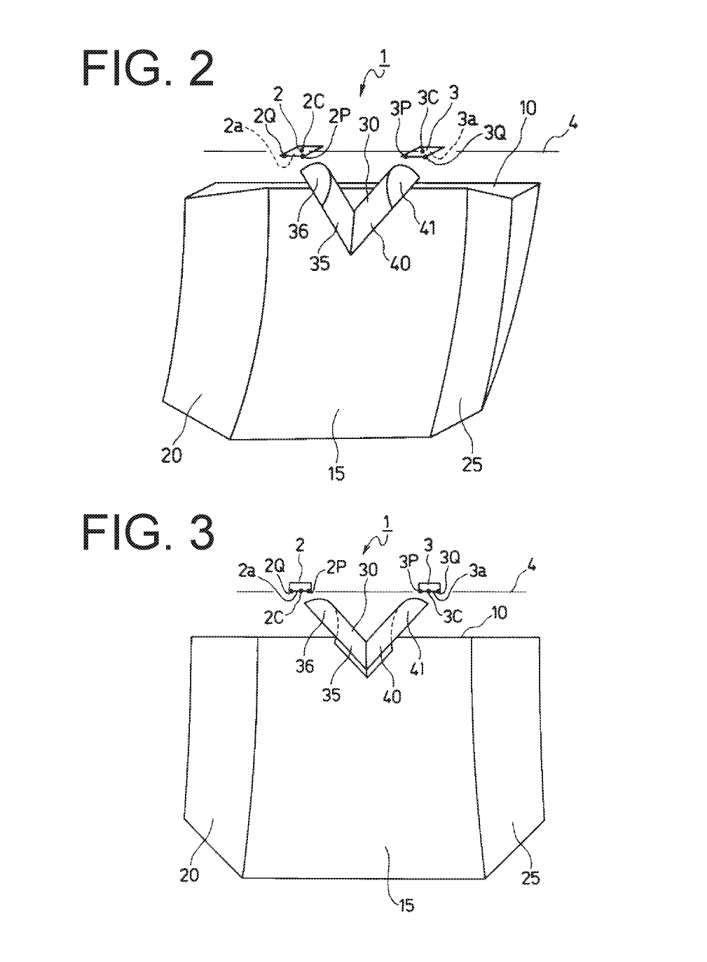

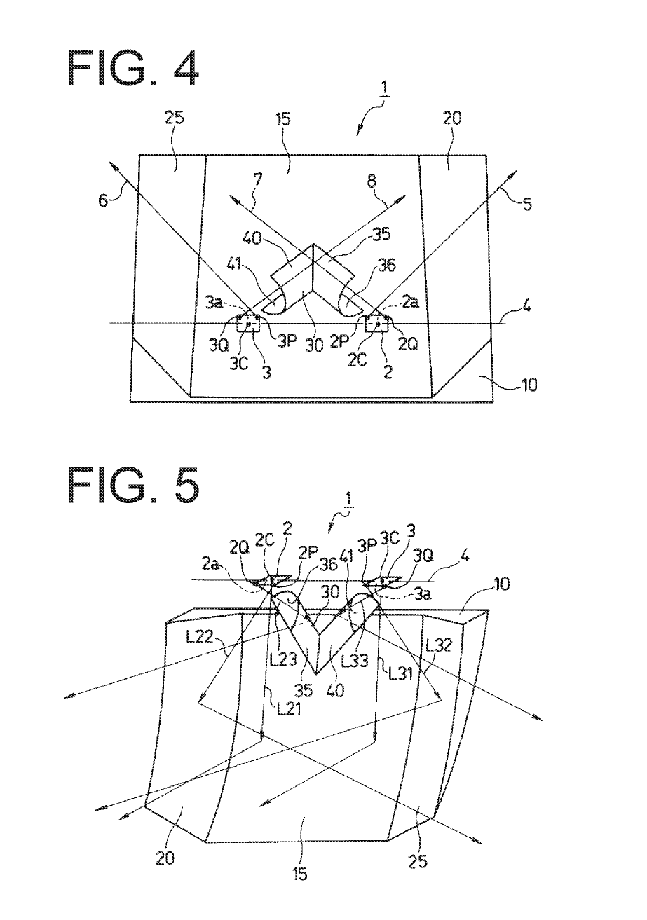

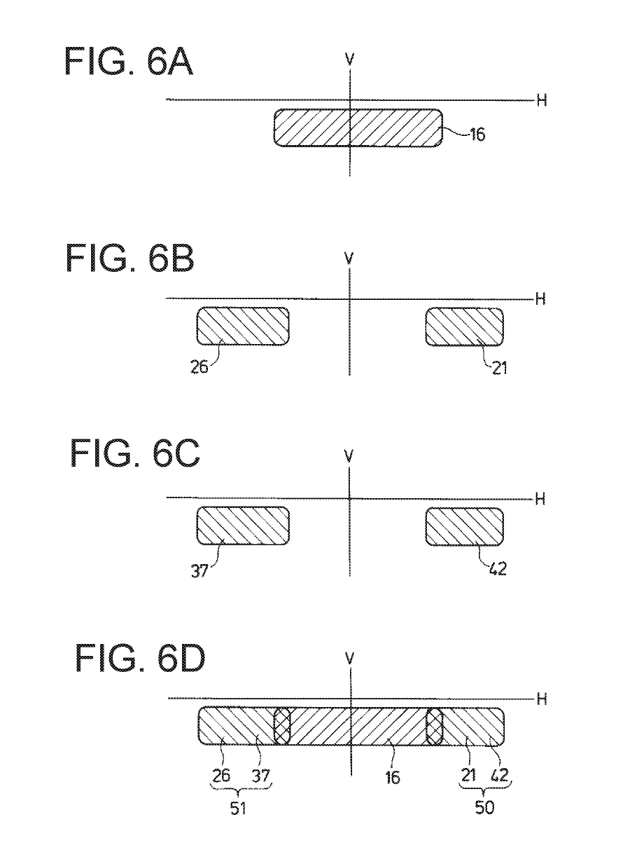

FIG. 2 is a perspective view of a vehicle lighting fixture 1 made in accordance with the principles of the presently disclosed subject matter when observed from an obliquely upper position. FIGS. 3 and 4 are a front view and a top view of the vehicle lighting fixture 1, respectively. FIG. 5 is a diagram illustrating emission light rays from the light sources. FIGS. 6A to 6D are diagrams each illustrating a light distribution pattern formed on a virtual vertical screen.

The vehicle lighting fixture 1 (hereinafter, simply referred to as “lighting fixture”) can be configured to a lighting apparatus to be attached to a front part of a vehicle body while the light irradiation direction thereof is directed forward of the vehicle body. Accordingly, the terms for describing directions of “front (forward),” “back (rearward),” “lateral (left, right),” “up (upward),” and “down (low, downward)” mean “a forward direction,” “rearward direction,” widthwise direction,” “upper direction,” and “lower direction” with respect to the vehicle body on which the lighting fixture 1 is installed.

The lighting fixture 1 of the presently disclosed subject matter can include two light sources 2 and 3, a single reflector 10 configured to have a reflecting function, and a single bent plate 30 configured to have both a light shielding function and a reflecting function. The respective components can be disposed in a bilaterally symmetric manner along the lateral direction.

As the light sources 2 and 3, there can be adopted a light source that can be configured to have a size substantially considered as an optically point light source with respect to an optical system including the reflector 10 and the bent plate 30. Specific examples thereof may include a light emitting diode (LED), which is used in the present exemplary embodiment. When the color of the lighting fixture 10 is needed to be white, the LED can a device including a blue LED element configured to emit blue light and a yellow wavelength converting phosphor configured to emit yellow light as a result of excitation by blue light in combination. This device can emit white light (pseud white light) by color mixing of part of blue light from the blue LED element and yellow light derived from the phosphor excited by another part of the blue light.

The light sources 2 and 3 can be disposed at respective left and right-side points with a predetermined gap therebetween.

The reflector 10 can include a center reflecting surface 15 positioned at center and two lateral reflecting surfaces 20 and 25 positioned on both sides of the center reflecting surface 15.

Among them, the center reflecting surface 15 can be disposed and extend from a position rearward and obliquely downward with respect to the light sources 2 and 3 to a position forward and obliquely downward via a position below the light sources 2 and 3. As a result, the entire shape of the center reflecting surface 15 can be a recessed curved shape extending from the rear position to the front position. Specifically, the center reflecting surface 15 can be formed from a paraboloidal columnar surface obtained by laterally moving a parabola having an axis inclined forward and downward, with the parabola having a focal point at a center 2C of an emission face 2a of the light source 2 or a center 3C of an emission face 3a of the light source 3.

Thus, the center reflecting surface 15 can have the paraboloidal columnar surface shape having a focal line 4 passing through the centers 2C and 3C of the emission faces 2a and 3a of the two point light sources 2 and 3 and the axis inclined forward and downward so as to reflect the light rays emitted from the two point light sources 2 and 3 to a forward and downward position in front of the vehicle lighting fixture 1.

The lateral reflecting surfaces 20 and 25 can obliquely laterally extend from each of lateral edges of the center reflecting surface to be formed as a recessed curved shape. Specifically, the lateral reflecting surfaces 20 and 25 can each be formed from a curved columnar surface obtained by moving a parabola obliquely sideward, with the parabola having a focal point located at a farthest front corner 2P, 3P of the emission face 2a, 3a of the point light source 2, 3 on a side closer to the lateral reflecting surface 20, 25 of interest and with an axis inclined forward, inward and downward.

In other words, the lateral reflecting surfaces 20 and 25 can each be a curved columnar surface having a focal line 5, 6 on a virtual line passing the farthest front corner 2P, 3P of the emission face 2a, 3a of the point light source 2, 3 on a side closer to the lateral reflecting surface 20, 25 of interest and extending obliquely laterally and with the axis inclined forward, inward and downward.

The bent plate 30 can be formed to have a substantially L-letter shape including plate portions 35 and 40 with a bent point interposed therebetween, having respective plate reflecting surfaces 36 and 41 while the bent point is located forward. The reflecting surface 36, 41 can be configured to be curved in a width direction and be concave rearward. The one plate portion 35 can be positioned on or near a line connecting the light source 2 and a center portion of the lateral reflecting surface 25 farther from the light source 2 while the other plate portion 40 can be positioned on or near a line connecting the light source 3 and a center portion of the lateral reflecting surface 20 farther from the light source 3.

The plate reflecting surfaces 36 and 41 can each be formed from a paraboloidal columnar surface obtained by moving a parabola obliquely forward and downward, with the parabola having a focal point located at a farthest front corner 2Q, 3Q of the emission face 2a, 3a of the point light source 2, 3 on a side closer to the plate reflecting surface 36, 41 of interest and with the axis inclined forward, outward and downward.

In other words, the plate reflecting surfaces 36 and 41 can each be a paraboloidal columnar surface having a focal line 7, 8 on a virtual line passing the farthest front corner 2Q, 3Q of the emission face 2a, 3a of the point light source 2, 3 on a side closer to the plate reflecting surface 36, 41 of interest and extending obliquely laterally and with the axis inclined forward, outward and downward.

A description will next be given of how the optical paths for the emission light rays from the respective light sources 2 and 3 can be formed by the optical system including the reflector 10 and the bent plate 30.

Light rays emitted from the light source 2 can mainly be directed to the center reflecting surface 15 and the lateral reflecting surface 20 of the reflector 10 and the plate reflecting surface 36 of the plate portion 35 of the bent plate 30. On the other hand, light rays emitted from the light source 3 can mainly be directed to the center reflecting surface 15 and the lateral reflecting surface 25 of the reflector 10 and the plate reflecting surface 41 of the plate portion 40 of the bent plate 30.

Specifically, light rays L21 and L31 emitted from the light sources 2 and 3 located on the focal line 4 of the paraboloidal columnar shaped center reflecting surface 15 and directed to the center reflecting surface 15 can be incident on the center reflecting surface 15 and reflected by the same. Then, the reflected light rays can be diffused laterally while the diffusion in the vertical direction is suppressed. As a result, the light rays can be projected to a forward and downward position in front of the vehicle lighting fixture 1.

When the projected image of the light rays is projected and observed on a virtual vertical screen (with a horizontal reference line H and a vertical reference line V) disposed in front of the vehicle lighting fixture 1, a light distribution pattern 16 as illustrated in FIG. 6A can be obtained. Specifically, the light distribution pattern 16 illustrated can be spread laterally long with a predetermined vertical width while projected below the horizontal reference line H and across the vertical reference line V.

Next, light rays 122 emitted from the light source 2 located on the focal line 5 of the curved columnar shaped lateral reflecting surface 20 with the farthest front corner 2P of the emission face 2a with respect to the lateral reflecting surface 20 being the focal point thereof and directed to the lateral reflecting surface 20 can be incident on the lateral reflecting surface 20 and reflected by the same. Then, the reflected light rays can be diffused laterally while the diffusion in the vertical direction is suppressed. As a result, the light rays can be projected to a forward, inward, and downward position in front of the vehicle lighting fixture 1.

On the other hand, light rays L32 emitted from the light source 3 located on the focal line 6 of the curved columnar shaped lateral reflecting surface 25 with the farthest front corner 3P of the emission face 3a with respect to the lateral reflecting surface 25 being the focal point thereof and directed to the lateral reflecting surface 25 can be incident on the lateral reflecting surface 25 and reflected by the same. Then, the reflected light rays can be diffused laterally while the diffusion in the vertical direction is suppressed. As a result, the light rays can be projected to a forward, inward, and downward position in front of the vehicle lighting fixture 1.

When the projected images of the light rays from the lateral reflecting surfaces 20 and 25 are projected and observed on the virtual vertical screen disposed in front of the vehicle lighting fixture 1, light distribution patterns 21 and 26 as illustrated in FIG. 6B can be obtained. Specifically, the light distribution pattern 21 illustrated can be spread laterally long with a predetermined vertical width while projected below the horizontal reference line H and on one side with respect to the vertical reference line V. Furthermore, the light distribution pattern 26 illustrated can be spread laterally long with a predetermined vertical width while projected below the horizontal reference line H and on the other side with respect to the vertical reference line V.

That is, the light distribution patterns 21 and 26 can be located at respective symmetric positions with respect to the vertical reference line V.

Next, light rays L23 emitted from the light source 2 located on the focal line 7 of the paraboloidal columnar shaped plate reflecting surface 36 with the farthest front corner 2Q of the emission face 2a with respect to the plate reflecting surface 36 being the focal point thereof and directed to the plate reflecting surface 36 can be incident on the plate reflecting surface 36 and reflected by the same. Then, the reflected light rays can be diffused laterally while the diffusion in the vertical direction is suppressed. As a result, the light rays can be projected to a forward, outward, and downward position in front of the vehicle lighting fixture 1.

On the other hand, light rays L33 emitted from the light source 3 located on the focal line 8 of the paraboloidal columnar shaped plate reflecting surface 41 with the farthest front corner 3Q of the emission face 3a with respect to the plate reflecting surface 41 being the focal point thereof and directed to the plate reflecting surface 41 can be incident on the plate reflecting surface 41 and reflected by the same. Then, the reflected light rays can be diffused laterally while the diffusion in the vertical direction is suppressed. As a result, the light rays can be projected to a forward, outward, and downward position in front of the vehicle lighting fixture 1.

When the projected images of the light rays from the plate reflecting surfaces 36 and 41 are projected and observed on the virtual vertical screen disposed in front of the vehicle lighting fixture 1, light distribution patterns 37 and 42 as illustrated in FIG. 6C can be obtained. Specifically, the light distribution pattern 37 illustrated can be spread laterally long with a predetermined vertical width while projected below the horizontal reference line H and on one side with respect to the vertical reference line V. Furthermore, the light distribution pattern 42 illustrated can be spread laterally long with a predetermined vertical width while projected below the horizontal reference line H and on the other side with respect to the vertical reference line V.

Accordingly, when the light distribution pattern 16 formed by the center reflecting surface 15, the light distribution patterns 21 and 26 formed by the respective lateral reflecting surfaces 20 and 25, and the light distribution patterns 37 and 42 formed by the respective plate reflecting surfaces 36 and 41 are observed on the same virtual vertical screen, a resulting light distribution pattern can be formed on the screen as illustrated in FIG. 6D.

Specifically illustrated in FIG. 6D, the light distribution pattern 16 can be formed below the horizontal reference line H and across the vertical reference line V. Furthermore, a synthesis light distribution pattern 50 can be formed by overlaying the light distribution patterns 21 and 42 on each other below the horizontal reference line H and on the one side with respect to the vertical reference line V. Another synthesis light distribution pattern 51 can be formed by overlaying the light distribution patterns 26 and 37 on each other below the horizontal reference line H and on the other side with respect to the vertical reference line V.

The synthesis light distribution pattern 50 and the light distribution pattern 16 can be overlaid in part so that the synthesis light distribution pattern 50 can extend outward from the one end of the light distribution pattern 16. On the other hand, the synthesis light distribution pattern 51 and the light distribution pattern 16 can be overlaid in part so that the synthesis light distribution pattern 50 can extend outward from the other end of the light distribution pattern 16. As a result, the synthesis light distribution pattern 50, the light distribution pattern 16, and the synthesis light distribution pattern 51 can form an integral light distribution pattern laterally long below the horizontal reference line 11 and across the vertical reference line V as illustrated in FIG. 6D.

In this case, the synthesis light distribution pattern 50, the light distribution pattern 16, and the synthesis light distribution pattern 51 can each be formed by light rays emitted from the two light sources 2 and 3. Thus, each of the light distribution patterns 50, 16, and 51 can be formed with high light intensity, thereby achieving the entire light distribution pattern with high light intensity over the entire region thereof.

Incidentally, if the plate reflecting surface 36 is not included (or the plate portion 35 is not included), the light rays emitted from the light source 2 and directed to the position of the not-included plate reflecting surface 36 can travel to the farther lateral reflecting surface 25 with respect to the light source 2 and be reflected by the same to form a light distribution pattern above the horizontal reference line H. Similarly, if the plate reflecting surface 41 is not included (or the plate portion 40 is not included), the light rays emitted from the light source 3 and directed to the position of the not-included plate reflecting surface 41 can travel to the farther lateral reflecting surface 20 with respect to the light source 3 and be reflected by the same to form a light distribution pattern above the horizontal reference line H. The resulting light distribution pattern includes the light components above the horizontal reference line H, resulting in generation of glare light to an oncoming vehicle and the like and deterioration of front visibility of a driver of an oncoming vehicle.

On the contrary, the lighting fixture according to the present exemplary embodiment can include the bent plate 30 on the optical paths, through which light rays emitted from the light sources 2 and 3 can pass to become glare light if there is no bent plate 30. Thus, the lighting fixture with the bent plate can prevent the generation of glare light by shielding light rays with the bent plate 30 while the shielded light rays can be effectively utilized by being reflected by the bent plate 30. The effective use of the light rays can increase the utilization efficiency of light and improve the light distribution pattern with higher light intensity.

Furthermore, the focal points of the curved columnar shaped lateral reflecting surfaces 20 and 25 can be disposed at the respective farthest front corners 2P and 3P of the emission faces 2a and 3a of the light sources 2 and 3 with respect to the lateral reflecting surfaces 20 and 25 of interest. This means that the respective lateral reflecting surfaces 20 and 25 can project the images formed at the respective focal points at the upper edges of the light distribution patterns 21 and 26 (or on the respective cut-off lines thereof). Therefore, since the respective farthest front corners 2P and 3P with respect to the lateral reflecting surfaces 20 and 25 of interest forming the upper edges of the light distribution patterns 21 and 26 can be at the same positions as the respective focal points thereof, light rays above the cut-off line can be prevented from being projected, thereby preventing the generation of glare light.

The focal points of the paraboloidal columnar shaped plate reflecting surfaces 36 and 41 can be disposed at the respective farthest front corners 2Q and 3Q of the emission faces 2a and 3a of the light sources 2 and 3 with respect the plate reflecting surfaces 36 and 41 of interest. This means that the respective plate reflecting surfaces 36 and 41 can project the images formed at the respective focal points at the upper edges of the light distribution patterns 37 and 42 (or on the respective cut-off lines thereof). Therefore, since the respective farthest front corners 2Q and 3Q with respect to the plate reflecting surfaces 36 and 41 of interest forming the upper edges of the light distribution patterns 37 and 42 can be at the same positions as the respective focal points thereof, light rays above the cut-off line can be prevented from being projected, thereby preventing the generation of glare light.

Note that the bent plate may not be provided with a reflecting surface, and may only serve as a light shielding member. In this case, also the vehicle lighting fixture can prevent the generation of glare light thereby ensuring front visibility of a driver of an oncoming vehicle.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle lighting fixture comprising:
two point light sources;
a reflector having reflecting surfaces configured to reflect light rays emitted from the two light sources; and
a light shielding member configured to shield part of the light rays emitted from the two light sources, wherein
the two point light sources each have an emission face, and are disposed on a same plane so that the emission faces face in a same direction,
the reflecting surfaces of the reflector include a center reflecting surface disposed below the two point light sources and lateral reflecting surfaces on both sides of the center reflecting surface, the lateral reflecting surfaces each including a center part,
the light shielding member is disposed on straight lines each connecting any one of the two point light sources and the center part of any farther one of the lateral reflecting surfaces with respect to the one point light source, and
the lateral reflecting surfaces are each formed from a curved columnar surface obtained by moving a parabola obliquely sideward, with the parabola having a focal point located at a farthest front corner of the emission face of the point light source on a side closer to the lateral reflecting surface of interest.

2. The vehicle lighting fixture according to claim 1, wherein the light shielding member includes a reflecting surface in substantially an L-letter shape, and
parts of the reflecting surface on both extension sides of the L-letter shape are each formed from a paraboloidal columnar surface obtained by moving a parabola obliquely forward and downward, with the parabola having a focal point located at a farthest front corner of the emission face of the point light source on a side closer to the part of the L-letter shaped reflecting surface of interest.

3. The vehicle lighting fixture according to claim 1, wherein the point light source is a light emitting diode.

4. The vehicle lighting fixture according to claim 2, wherein the point light source is a light emitting diode.

5. The vehicle lighting fixture according to claim 1, wherein the center reflecting surface disposed below the two point light sources is formed from a paraboloidal columnar surface obtained by laterally moving a parabola having an axis inclined forward and downward, with the parabola having a focal line passing through centers of the emission faces of the two point light sources so as to reflect the light rays emitted from the two point light sources to a forward and downward position in front of the vehicle lighting fixture.

6. The vehicle lighting fixture according to claim 2, wherein the center reflecting surface disposed below the two point light sources is formed from a paraboloidal columnar surface obtained by laterally moving a parabola having an axis inclined forward and downward, with the parabola having a focal line passing through centers of the emission faces of the two point light sources so as to reflect the light rays emitted from the the two point light sources to a forward and downward position in front of the vehicle lighting fixture.

7. The vehicle lighting fixture according to claim 3, wherein the center reflecting surface disposed below the two point light sources is formed from a paraboloidal columnar surface obtained by laterally moving a parabola having an axis inclined forward and downward, with the parabola having a focal line passing through centers of the emission faces of the two point light sources so as to reflect the light rays emitted from the two point light sources to a forward and downward position in front of the vehicle lighting fixture.

8. The vehicle lighting fixture according to claim 4, wherein the center reflecting surface disposed below the two point light sources is formed from a paraboloidal columnar surface obtained by laterally moving a parabola having an axis inclined forward and downward, with the parabola having a focal line passing through centers of the emission faces of the two point light sources so as to reflect the light rays emitted from the two point light sources to a forward and downward position in front of the vehicle lighting fixture.

9. The vehicle lighting fixture according to claim 1, wherein the lateral reflecting surfaces disposed on both the sides of the center reflecting surface are configured to reflect the light rays emitted from the two point light sources to a forward, inward and downward position in front of the vehicle lighting fixture.

10. The vehicle lighting fixture according to claim 2, wherein the lateral reflecting surfaces disposed on both the sides of the center reflecting surface are configured to reflect the light rays emitted from the two point light sources to a forward, inward and downward position in front of the vehicle lighting fixture.

11. The vehicle lighting fixture according to claim 5, wherein the lateral reflecting surfaces disposed on both the sides of the center reflecting surface are configured to reflect the light rays emitted from the two point light sources to a forward, inward and downward position in front of the vehicle lighting fixture.

12. The vehicle lighting fixture according to claim 1, wherein the light shielding portion is configured to shield the light rays emitted from the two point light sources and directed to any farther one of the lateral reflecting surfaces.

13. The vehicle lighting fixture according to claim 2, wherein the light shielding portion is configured to shield the light rays emitted from the two point light sources and directed to any farther one of the lateral reflecting surfaces.

14. The vehicle lighting fixture according to claim 5, wherein the light shielding portion is configured to shield the light rays emitted from the two point light sources and directed to any farther one of the lateral reflecting surfaces.

15. The vehicle lighting fixture according to claim 9, wherein the light shielding portion is configured to shield the light rays emitted from the two point light sources and directed to any farther one of the lateral reflecting surfaces.
